(19) United States
(12) Patent Application Publication
(10) Pub. No.: US 2009/0245145 A1
(43) Pub. Date: Oct. 1, 2009

(54) EXTENDING THE RANGE OF A HAND-PORTABLE RADIO

(75) Inventor: Nicholas Richard Pennance, Christchurch (NZ)

Correspondence Address: DENNISON, SCHULTZ & MACDONALD, 1727 KING STREET, SUITE 105, ALEXANDRIA, VA, 22314, US

(73) Assignee: TAIT ELECTRONICS LIMITED, Christchurch (NZ)

(21) Appl. No.: 10/597,339

(22) PCT Filed: Jan. 27, 2005
(86) PCT No.: PCT/NZ05/00007

§ 371 Date: Sep. 6, 2006

Related U.S. Application Data
(60) Provisional application No. 60/539,617, filed on Jan. 27, 2004.

(30) Foreign Application Priority Data
Jan. 27, 2004 (NZ) 530819

(51) Int. Cl. H04L 5/16; H04W 4/00

(52) U.S. Cl. 370/277; 370/328

(57) ABSTRACT

A repeater system for hand portable radios that may be outside normal coverage in a mobile radio system. Short messages or emergency messages from the portable radio are transmitted to an on-board or other mobile station, and forwarded from there to a central station or other required station in the system. The on-board station generally has a higher powered transmitter than the portable station and is within network coverage when the messages are received. The on-board station might be carried by a vehicle for example, and the portable station might be carried by a public safety official who has left the vehicle to investigate a nearby event.

### FIELD OF THE INVENTION

This invention relates to mobile radio networks in which hand-portable terminals may be required to operate throughout a large geographical area without necessarily being in direct communication with network infrastructure. The invention relates particularly but not only to radio networks used by public safety organisations and conforming to standards determined by APCO (Association of Public-Safety Communications Officials) such as APCO 25.

### BACKGROUND TO THE INVENTION

Public safety organisations such as those providing police, fire, health and rescue services often operate mobile radio networks requiring coverage over large geographical areas. The networks typically have a private infrastructure including a central dispatcher station and a number of base stations distributed throughout the area of the organisation's responsibility, with large numbers of on-board stations for service vehicles and hand-portable stations for individual officers. The hand-portable stations can provide lifelines for the officers in dangerous or otherwise difficult situations.

Hand-portable stations are generally much lower powered than on-board stations, and have considerably lower range in both transmission and reception of signals from the network infrastructure. Both kinds of stations, sometimes called mobiles, units or terminals are able to communicate directly with the network, although the hand-portable stations are sometimes out of range. The coverage area of a hand-portable station is therefore sometimes extended by providing an on-board repeater that operates alongside an existing on-board station and connects the hand-portable to the network through the on-board station. Network control information is passed from the on-board station through the on-board repeater, to and from the hand-portable so the hand-portable can receive and initiate calls.

Many public safety organisations operate in relatively poor countries or in extended regions of low population, and lack the financial resources of organisations that operate in large Western cities. They require mobile radio networks conforming to a particular standard but may not have sufficient resources to provide fully compliant equipment for their officers and vehicles. In the case of APCO 25 a fully compliant repeater would require two full duplex on-board stations to successfully set up a normal voice or data call, and is a relatively expensive piece of equipment. More complex equipment usually involves more difficult technical issues, additional hardware, and requires additional time in development.

### SUMMARY OF THE INVENTION

It is an object of the invention to provide a relatively simple solution for partially extending the range of hand-portable radio equipment, or at least to provide an alternative to existing systems. In general terms, an on-board radio stores and forwards incoming or outgoing messages between the hand-portable and other stations in the network, avoiding the need to provide a fully functional repeater.

In one aspect the invention therefore resides in a system for mobile radio communication, including: a network having one or more radio base stations and a central station, an on-board radio station having a relatively long range for communication with other stations, and a portable radio station having a relatively short range for communication with other stations, wherein the on-board station receives and forwards messages between the portable station and the network when the on-board station is within range of the network but the portable station is out of range of the network.

In one embodiment, the central station is a dispatcher and the on-board station receives and forwards emergency messages or other short messages from the hand-portable station to the dispatcher when the hand-portable station is out of direct contact with the network. The messages are preferably in SDM format. In general however, a wide range of messages may be transmitted between the hand-portable and the on-board station, and elsewhere in the network.

In another aspect the invention resides in a method of communication in a mobile radio system, including: determining in a portable radio station that network coverage is not available at the portable station, transmitting a message from the portable station over a half-duplex channel to an on-board radio station at which network coverage is available, and forwarding the message from the on-board radio station to a central station in the system.

In another aspect the invention resides in a method of communication in a mobile radio network, including: receiving a message at a first radio station at which network coverage is available, from a second radio station at which network coverage is not available, determining that the message is addressed to a central radio station in the network, and forwarding the message from the first station to the central station through the network.

### LIST OF FIGURES

Preferred embodiments of the invention will be described with respect to the accompanying drawings, of which:

FIG. 1 shows a simple mobile radio network including a dispatcher, and a hand-portable radio station associated with an on-board station,

FIG. 2 indicates broadly how a message is transmitted from the hand-portable station through the on-board station to the dispatcher,

FIG. 3 schematically shows radio equipment that may be used for either or both of the on-board and hand-portable stations,

FIG. 4 outlines a process by which an on-board station is activated for transmission of messages to and from the hand-portable,

FIG. 5 outlines a successful transmission from the hand portable station through the on-board station to the dispatcher,

FIG. 6 outlines an unsuccessful transmission from the hand-portable station to the dispatcher, and

FIG. 7 outlines operation of the on-board station when receiving and forwarding messages to and from the hand-portable station.

### DETAILED DESCRIPTION OF PREFERRED EMBODIMENTS

Referring to the drawings it will be appreciated that the invention may be implemented in various ways for a variety of purposes. The embodiments described here are given by way of example only. Most features of a mobile radio network will be understood by a skilled reader and need not be described in detail.

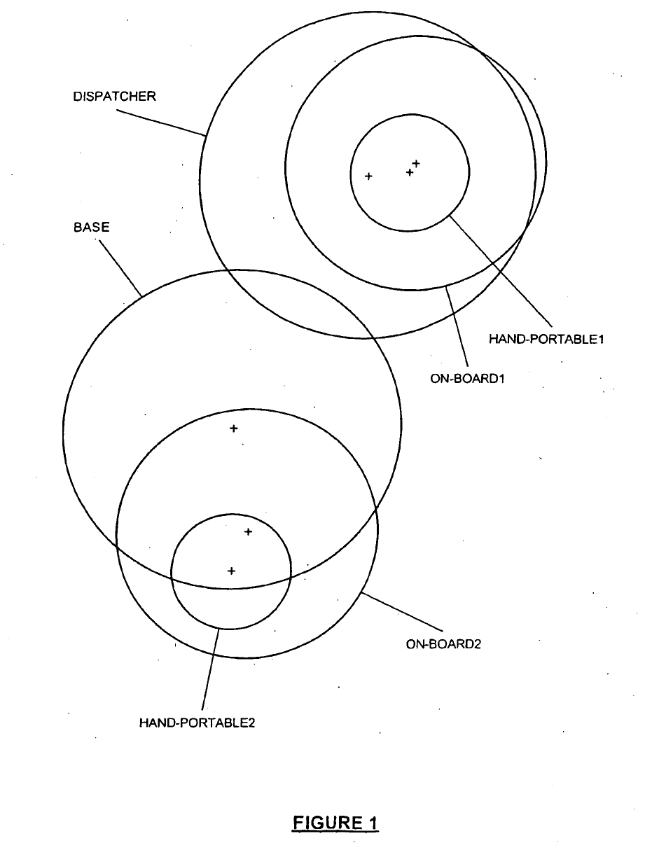

FIG. 1 shows the coverage of a simple mobile radio network having two fixed stations. In this example there is a central station namely a dispatcher, that is normally attended by an operator, and a single automated base station. Networks are arranged to meet the needs of a particular organisation. Some networks have many base stations connected by landline or microwave links. In some cases a dispatcher is not required. Two on-board stations are also shown, with associated hand-portable stations, although in general there will be many stations of this kind for dozens or perhaps hundreds of mobile users. They may be digital or analog radios. In the case of a public safety organisation, the on-board station would typically be mounted in a service vehicle while the hand-portable station would be carried by an officer of the organisation. The coverage areas for each station are idealised as circles representing the area within which the respective station can communicate directly with an on-board station. In practice the areas would be irregular and depend on the surrounding geography, and the transmission power level and the sensitivity of reception at each station.

It can be seen in FIG. 1 that the hand-portable stations have a limited range and will often be out of contact with any of the fixed stations which form the network. The on-board stations are powered by the vehicle in which they are mounted and have a relatively long contact range substantially the same as the fixed stations. Both hand-portable1 and on-board1 are in direct contact with the dispatcher station and can communicate with the network independently of each other. The officer carrying hand-portable1 is probably in the vehicle carrying on-board1. On the other hand, while on-board2 is in contact with the base station, hand-portable2 is out of direct contact with the network and can only communicate with other stations through on-board2 as a repeater. The officer carrying hand-portable2 is probably out of the vehicle that carries on-board2. In the case of a police organisation, this could represent a police officer investigating a possible crime scene, for example. It is important for an officer under circumstances of this kind to be able to send an emergency message to the dispatcher. Similarly, the dispatcher may need to send a message to the officer.

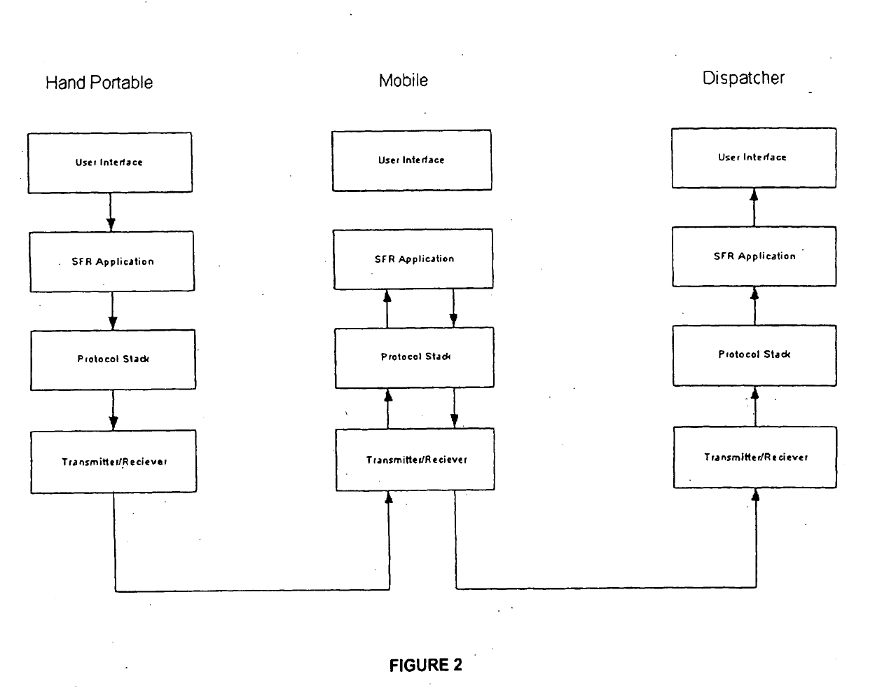

FIG. 2 schematically shows how coverage for a hand-portable station may be extended by operating a respective on-board station as a store and forward repeater (SFR). In this example, the hand-portable sends a voice or data message to the dispatcher through the on-board station, although in general, messages may be sent in either direction, to or from any other fixed or mobile station in the network. The hand-portable has functionality to transmit and receive messages to and from an associated on-board station. The on-board in turn has functionality to receive and store messages from the hand-portable station addressed to the dispatcher or other stations using the network, initiate calls to the other stations, and transmit the stored messages. Similarly the on-board has functionality to receive and store messages addressed to the hand-portable station from elsewhere in the network, initiate calls to the hand-portable, and transmit the messages to the hand-portable. The dispatcher has functionality to transmit and receive messages to and from band-portables using respective on-board stations as repeaters.

Each of the hand-portable, on-board and dispatcher stations in FIG. 2 typically has a user interface, a respective SFR software application, a protocol stack containing processes required by the particular network, and a full duplex transmitter/receiver. All of the stations are preferably software radios, and if SFR communications are limited to a half-duplex channel between the band-portable and on-board stations, then no additional hardware is required to create the repeater. An SFR application with an ability to receive, store and retransmit voice and data messages to and from another station resides in each of the mobile stations, so in general, either could serve as a repeater for the other. The hand-portable and on-board stations are normally assigned or registered together in pairs, with their respective call numbers and a communication channel being programmed during setup for use in a particular network. Pairs may also be registered or deregistered by messages sent over the network by users once the hand-portable and on-board stations are operational. Assignments of multiple hand-portables to a single on-board station are possible, although problems of channel contention can then arise. Assignments of a single hand-portable to multiple on-board stations may also be registered, although mechanisms for selecting which on-board station is most suitable as a repeater in a particular instance is then required.

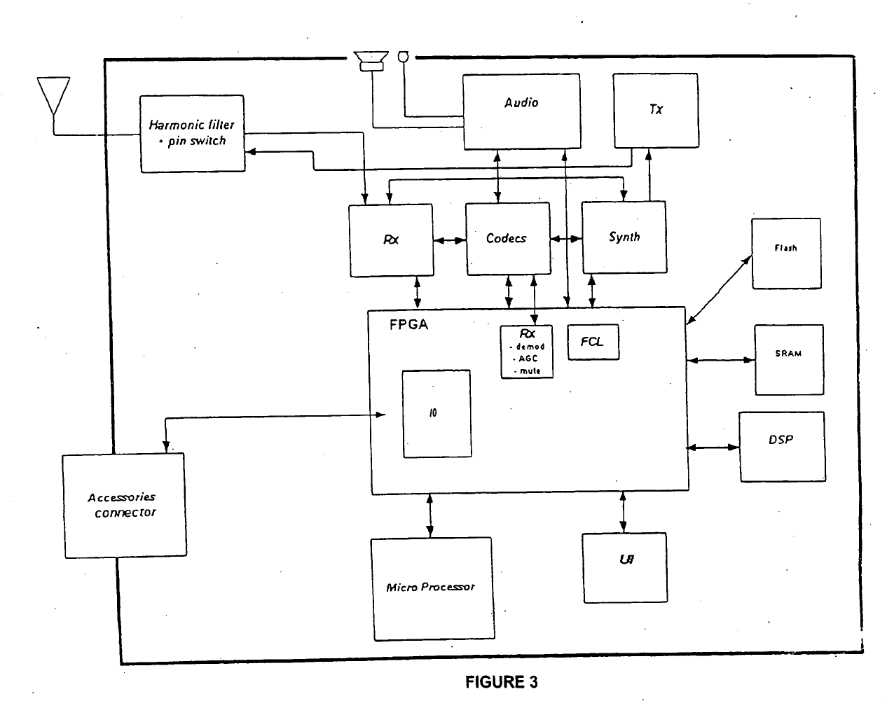

FIG. 3 shows a preferred implementation of the hand-portable and on-board stations as software radios. The hardware components of the radios will be known to a skilled reader and need not be described in detail. In this example, a microprocessor and FPGA control operation of the user interface and upper layers of the protocol stack. A DSP controls operation of lower layers of the stack. Software such as that required for the SFR application are stored in flash memory, while programming data and intermittent data such as voice messages are stored in SRAM or flash memory. The user interface typically includes a keypad and display, and a set of pin switches. Audio components of the radio include a microphone, speaker and a separate audio processing stage. An antenna, transmitter, receiver, frequency synthesiser and codec are provided for RF communication with other stations. Connectors are provided for data input and output to accessories such as a GPS (Global Positioning System) device or a laptop computer, for example. A power source in the form of a battery or connection to the electrical system of a vehicle is provided.

Operation of the repeater feature will generally be controlled from the hand-portable station, and enabled either manually by the user or automatically by the hand-portable. The feature will generally need to be enabled before any messages can be sent, except in the case of an emergency alert, either outgoing or incoming to the hand-portable. A location call could also be provided by way of an intermittent transmission of GPS position data to the dispatcher. Incoming call alerts could also be provided for the hand-portable by the on-board station. Emergency, location and call alert modes will be available for selection during setup of each radio. In general, voice and data messages transmitted from or to the hand-portable are recorded in the on-board station and retransmitted as soon as possible once the call in which the message was delivered has ended. Stored messages will generally remain in memory until the space they occupy is needed for a new message, and may therefore be transmitted again if required. The SFR application will also generally store the source address of a message so that a direct reply can be made if necessary.

A protocol for the repeater feature may be provided separately or developed using short data messages that are already available over the network. In the APCO standard for example, a 16 bit field is allowed for short data messages, including messages that could become part of an SFR protocol, such as enable/disable and success/failure messages. SDM messages including ACTIVATE, ACTIVE, DISABLE, DISABLED, SUCCESS, FAIL are used in the following figures. The general term “mobile” is used for the on-board station in these figures.

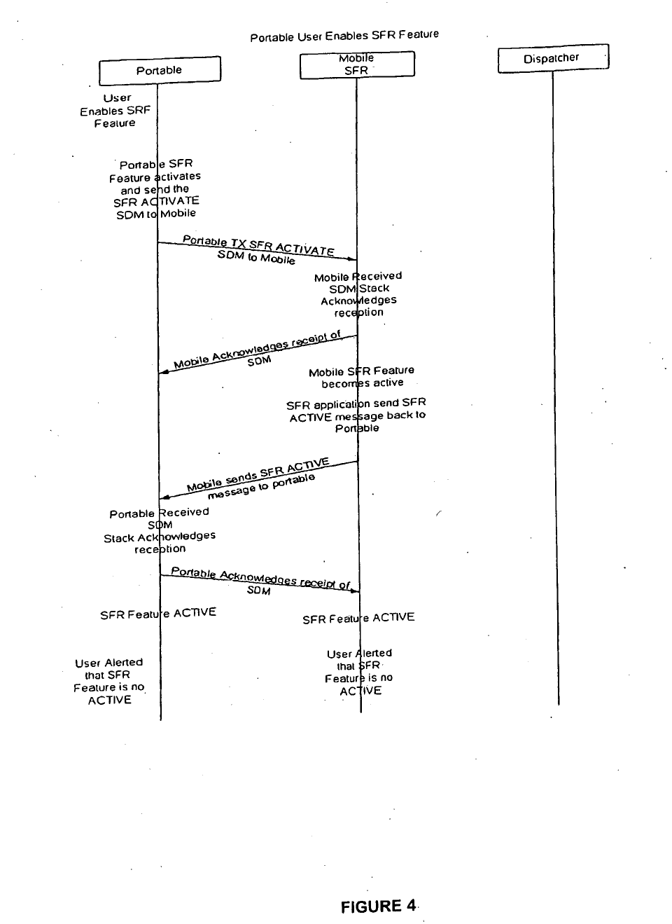

FIG. 4 outlines a call sequence in which the SFR mode is enabled by transmission of an ACTIVATE SDM from the hand-portable to the on-board station, followed by transmission of an ACTIVE SDM from the on-board to the hand-portable station. Acknowledgment messages are also preferably sent in each case to cancel retry timers in the respective stations. Transmission of the ACTIVATE SDM could be initiated by the user on pressing a key or selecting from a menu in the display, or by the hand-portable in the absence of network signalling or in the absence of a response to a previous message. The mode can be disabled in a similar fashion by transmission of DISABLE and DISABLED SDMs.

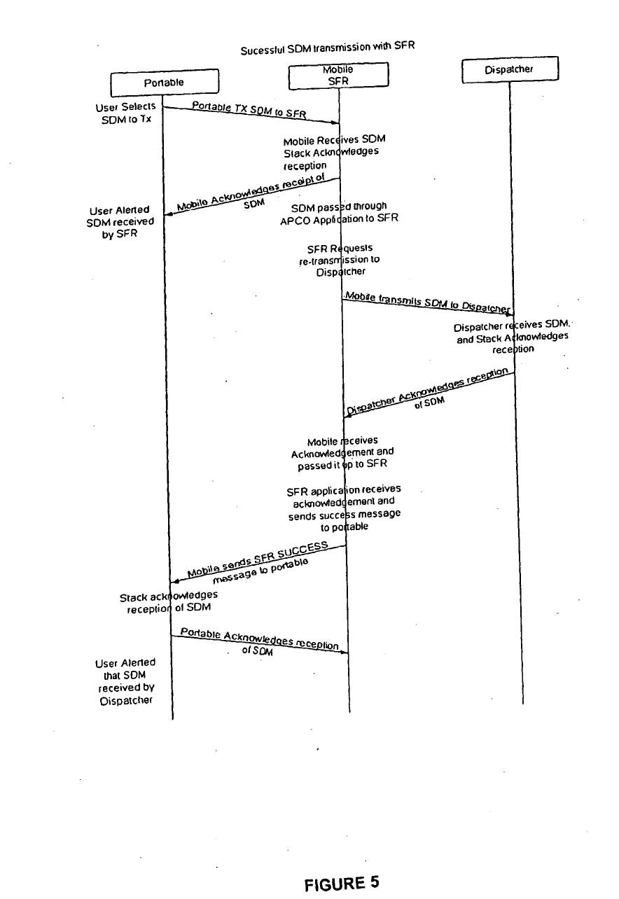

FIG. 5 outlines a successful SFR call from the hand-portable. The on-board station is initially scanning for calls, including calls either outgoing or incoming in relation to the hand-portable station. The hand-portable requests transmission of an SDM as a message either entered by the user, or automatically generated, such as an emergency message for example. The on-board stores the SDM and initiates a new call to an appropriate station in the network, usually the dispatcher in the case of an emergency message, and transmits the message. The on-board sends an SFR SUCCESS SDM to the hand-portable. Acknowledgment messages are preferably sent at each stage.

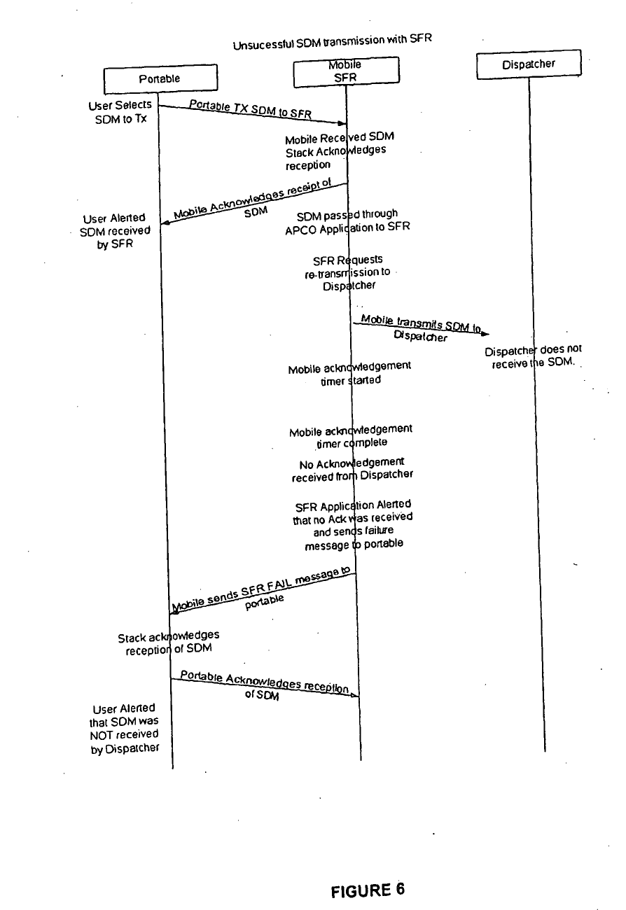

FIG. 6 outlines a call sequence in which an SDM sent by the hand-portable is not successfully received by the dispatcher. In this case an acknowledgment of the SDM sent by the on-board station is not received from the dispatcher for some reason. The on-board station sends an SFR FALL SDM to the hand-portable and may continue trying to contact the dispatcher.

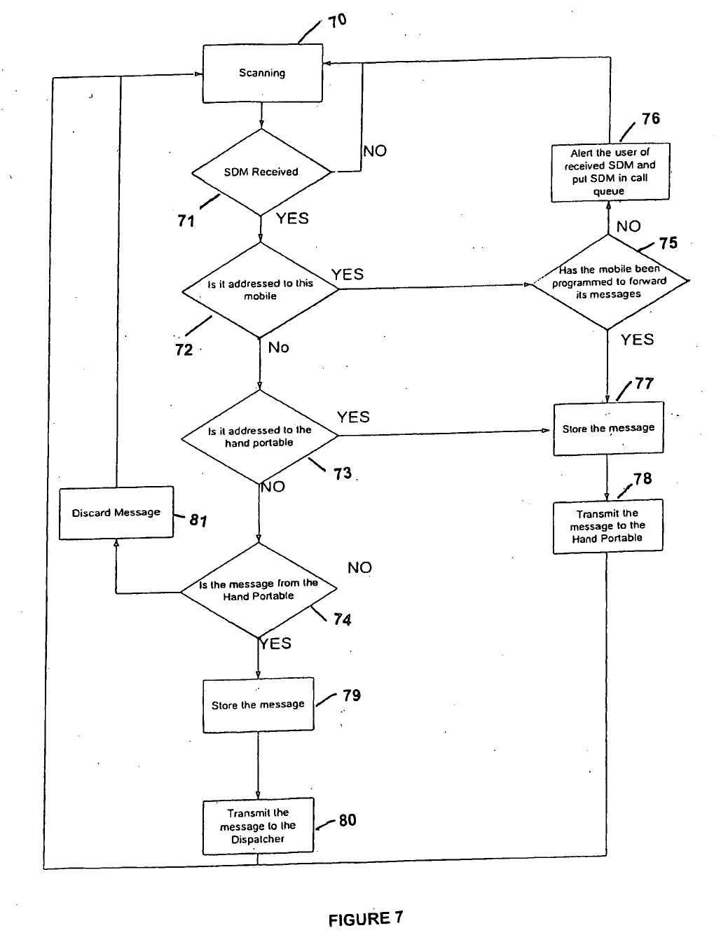

FIG. 7 is a flowchart summarising the typical action of an on-board or mobile station as a repeater for messages to and from an associated hand-portable station. The SFR mode must first be enabled because in general the on-board station will ignore calls that are not addressed to the on-board station. The on-board distinguishes between messages addressed to itself, messages addressed to the hand-portable, and messages from the hand-portable addressed to other stations in the network. The messages are stored and forwarded to the appropriate destination.

In FIG. 7, the on-board station is scanning 70 in the SFR mode 70 when a new message is received 71. Processing of the message is determined by a series of steps 72, 73, 74 according to whether the message is addressed to on-board station or to the hand portable, or received from the hand portable respectively. If the message is addressed to the on-board station itself, as determined in step 72, then further action depends on whether or not the SFR mode is set to forward all messages to the portable station, as determined in step 75. If not, the message is queued 76 for a user action in the usual way. Otherwise the message is stored 77 and then transmitted 78 to the portable station.

Transmission usually takes place on a pre-programmed channel different from the channel on which the message was received. If the message is addressed to the portable station, as determined in step 73, the message is similarly stored 77 and then transmitted 78. If the message is from the portable station, as determined in step 74, then the message stored 79 and transmitted 80 to the dispatcher, or to another station as required. Otherwise the message is discarded 81.

A simple repeater system of the kind described in this example may be implemented in various ways within the scope of the following claims.

1. A system for mobile radio communication, including:
a network having one or more radio base stations and a central station;
an on-board radio station having a relatively long range for communication with other stations; and
a portable radio station having a relatively short range for communication with other stations;
wherein the on-board station receives messages from the portable station over a half duplex channel when the on-board station is within range of the network but the portable station is out of range of the network, stores the messages and forwards the messages to the network over a different radio channel.

2. A system according to claim 1 wherein the on-board station receives and forwards emergency messages from the portable station to the central station.

3. A system according to claim 1 wherein the portable station and the on-board station communicate short data messages or voice messages in either direction over a half-duplex radio channel.

4. A system according to claim 1 wherein the portable and on-board stations each have a duplex mode for communication with the network by voice or data calls and a half-duplex mode for communication between each other by short messages.

5. A system according to claim 1 wherein the on-board station is carried by a vehicle and the portable station is carried by an individual associated with the vehicle.

6. A method of communication in a mobile radio system, including:
determining in a portable radio station that network coverage is not available at the portable station;
transmitting a message from the portable station over a half-duplex channel to an on-board radio station at which network coverage is available; and
forwarding the message from the on-board radio station to a central station in the system.

7. A method according to claim 6 wherein the on-board station receives messages from the portable station on one channel and transmits the messages on a different channel.

8. A method according to claim 6 wherein the message is an emergency message.

9. A method of communication in a mobile radio network, including:
opening a half duplex radio channel between a portable station at which network coverage is not available and an on-board station at which network coverage is available;
transmitting a message from the portable station to the on-board station over the half duplex channel;
receiving and storing the message at the on-board station;
determining that the message is addressed to a central radio station in the network;
opening further radio channel between the on-board station and the central station; and
forwarding the message from the on-board station to the central station through the network.

10. (canceled)
